(19) United States
(12) Patent Application Publication
(10) Pub. No.: US 2024/0420453 A1
(43) Pub. Date: Dec. 19, 2024

(54) SYNTHETIC DATA GENERATION FOR MACHINE LEARNING MODELS

(71) Applicant: Amazon Technologies, Inc., Seattle, WA (US)

(72) Inventors: Rahul Gupta, Waltham, MA (US); Ninareh Mehrabi, Glendale, CA (US); Palash Goyal, San Jose, CA (US); Kai-Wei Chang, Los Angeles, CA (US); Aram Galstyan, Los Angeles, CA (US)

(21) Appl. No.: 18/216,271

(22) Filed: Jun. 29, 2023

Related U.S. Application Data
(60) Provisional application No. 63/521,267, filed on Jun. 15, 2023.

(51) Int. Cl. G06V 10/772; G06F 40/30; G06F 40/40; G06V 10/774

(52) U.S. Cl. CPC G06V 10/772; G06F 40/30; G06F 40/40; G06V 10/774

(57) ABSTRACT

Techniques for generating synthetic data for machine learning (ML) models are described. A system includes a language model that processes a task and a corresponding set of example inputs to generate another input, referred to herein as a machine-generated data. The machine-generated data is processed using a ML, model (that data is being generated for) to determine a model output, and the model output is analyzed to determine whether it corresponds to a target output. If the model output corresponds to the target output, then the machine-generated data is added to the set of example inputs and one of the original example inputs is removed to generate an updated set of example inputs. The updated set can be used for various training techniques.

### CROSS-REFERENCE TO RELATED APPLICATION

This application claims the benefit of priority under 35 U.S.C. § 119(e) of U.S. Provisional Patent Application No. 63/521,267, filed Jun. 15, 2023, and entitled “CONTROLLING MODEL OUTPUT”, the entire contents of which is incorporated herein by reference for all purposes.

### BACKGROUND

Machine learning is a computing technique whereby a computing system can learn how to perform a specific task without explicitly being programmed to do so. Machine learning may be used to handle a number of different tasks of varying complexity. Machine learning computing may rely on trained models that are trained using training data sets. Once trained, a machine learning model may be capable of processing input data and producing output data that conforms to the function for which the model has been trained.

### BRIEF DESCRIPTION OF DRAWINGS

For a more complete understanding of the present disclosure, reference is now made to the following description taken in conjunction with the accompanying drawings.

FIG. 1 is a conceptual diagram illustrating an example system for generating synthetic data for machine learning (IL) models, according to embodiments of the present disclosure.

FIG. 2 is a conceptual diagram illustrating processing that may be performed by an examples evaluation component, according to embodiments of the present disclosure.

FIG. 3 is a conceptual diagram illustrating how machine-generated examples can be used for ML model training, according to embodiments of the present disclosure.

FIG. 4 is a flowchart illustrating an example process that may be performed to generate synthetic data for adversarial training of a ML model, according to embodiments of the present disclosure.

FIG. 5 is a conceptual diagram of components of the system, according to embodiments of the present disclosure.

FIG. 6 is a conceptual diagram illustrating components that may be included in a device, according to embodiments of the present disclosure.

FIG. 7 is a block diagram conceptually illustrating example components of a device, according to embodiments of the present disclosure.

FIG. 8 is a block diagram conceptually illustrating example components of a system, according to embodiments of the present disclosure.

FIG. 9 illustrates an example of a computer network for use with the overall system, according to embodiments of the present disclosure.

### DETAILED DESCRIPTION

Machine learning (ML) is a valuable computing technique that allows computing systems to learn techniques for solving complex problems without needing an explicit algorithm for the computing system to follow. ML may use a trained model that consists of internally configured operations that can manipulate a particular type of input data to determine a desired result. Trained models are used in many computing tasks such as computer vision, speech processing, predictive analyses, and many more.

Trained models come in a variety of forms including trained classifiers, Support Vector Machines (SVMs), neural networks (such as deep neural networks (DNNs), recurrent neural networks (RNNs), or convolutional neural networks (CNNs)), language models and others. As an example, a neural network typically includes an input layer, an output layer and one or more intermediate hidden layers where the input layer is configured to take in a certain kind of data and the output layer is configured to output the desired kind of data to result from the network and the hidden layer(s) perform a variety of functions to generate output data from the input data.

Various techniques may be used to train ML models including backpropagation, statistical learning, supervised learning, semi-supervised learning, stochastic learning, adversarial training, or other known techniques. In supervised learning a model may be configured to infer a function from labeled training data. Thus a computing system may use training data in the form of training examples that provide examples of the kinds of input data the model will be configured to process at runtime as well as an accompanying “ground truth” for each training example. The ground truth provides the correct response for the respective training example, thus providing a complete example that can be used to train the model. Other data that may be used to train a model may include training parameters such as error functions, weights or other data that can be used to guide the training of a model.

The present disclosure relates to techniques for using a language model (e.g., a large language model) to generate synthetic data for ML models. A system of the present disclosure can be used to generate diverse and more effective samples for training ML models and for various types of training techniques. The system, in some embodiments, includes a language model that is capable of using in-context examples/learning along with a task description to generate a response as described in the task. The prompt, in the present disclosure, may be used to cause the language model to generate desired synthetic data. For example, a prompt including an example task “Generate a request for an image including a family” and example inputs “image with a woman and a man”, “image with two people and one or more children”, “image with a dog and two persons”, “image with older persons and younger persons” may be provided to the language model.

Based on in-context learning, a language model can learn to solve a new task at inference time, without any changes to its weights or model parameters, by being fed a prompt with examples of that task. Without any further fine-tuning, a pre-trained language model is able to learn to do something entirely new by merely being shown a few input-output examples. The present disclosure takes advantage of in-context learning to generate examples/synthetic data to be used by ML models.

The language model may process the prompt and generate a response (e.g., a natural language response), which is referred to herein as a machine-generated input since it is used as an input to a ML model. The system can further include a ML model. The machine-generated input is processed by the ML model configured to perform at least the task described in the prompt. For example, the machine-generated input may be provided to a ML model configured to generate an image from a text input (a text-to-image generation model). In some embodiments, the ML model of the system may be a reference model, a test model, etc. that is other than a live/runtime model that may be used to process “live” inputs, for example, from a user.

The ML model may process the machine-generated input and generate a model output. The system can further include a model output evaluation component that may analyze the model output to determine whether it corresponds to a target output. For example, the ML model may generate an image including two persons and a child, and the model output evaluation component may determine that the generated image satisfies a target output of an image including a family. As another example, the ML model may generate an image including one person and one dog, and the model output evaluation component may determine that the generated image does not satisfy the target output of an image including a family, where a family is defined as including a child for this particular image generation task.

Based on the model output corresponding to a target output, the system may determine whether the machine-generated input is to be included as an example (sample). The system may use the original examples, included in the prompt to the language model, to determine a new (updated) set of examples that includes the machine-generated input. In some embodiments, the system may remove one of the original examples and include the machine-generated input in the new set. The machine-generated input may be included in the new set based on the machine-generated input improving an overall semantic diversity of the set, where the set includes example inputs with varying words and minimizes use of same words among the examples. Diversity in the examples can ensure that the ML model trained using such examples is more robust and is capable of handling variety of inputs.

In other embodiments, the machine-generated input may be included in the new set based on a corresponding score representing how likely the machine-generated input is to cause generation of the target output by the ML model. In yet other embodiments, the set may be an ordered list, the system may remove the first example in the list and add the machine-generated input to the beginning of the list or to the end of the list. The new set of examples may be used as training samples.

The system can be used to generate training samples (e.g., positive samples of a task the ML model is configured for) that can be used to train a ML model(s) for a particular task. In other cases, the system can be used to generate training samples (e.g., negative samples illustrating what the ML model is not to generate) that can be used for adversarial training techniques for a particular task. In yet other cases, the system can be used to generate training samples for configuring another ML model(s) that may act as a content moderation model for a ML model that perform the particular task. In some cases, the system can be used to generate both positive samples, which result in a desired output from the ML model, and negative samples, which result in an undesired output from the ML model, and use both to train a more robust ML model.

The system can be used to generate training samples for generative ML models. A generative model includes the distribution of the data itself, and can determine how likely a given example is. For example, a generative model can predict the next word in a sequence as they can assign a probability to a sequence of words. For example, in some embodiments, the system may be used to generate training samples for a text-to-text generation model. As another example, in some embodiments, the system may be used to generate training samples for a text-to-image generation model.

Teachings of the present disclosure provide, among other things, techniques for generating diverse synthetic data that can be used for ML models and techniques for generating effective synthetic data that satisfy a target goal(s).

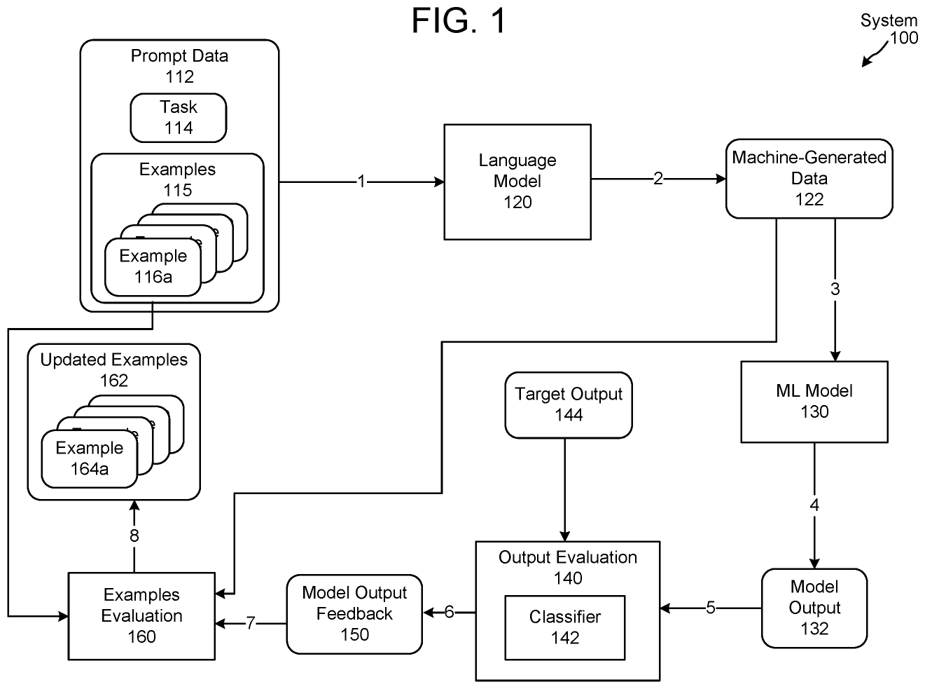

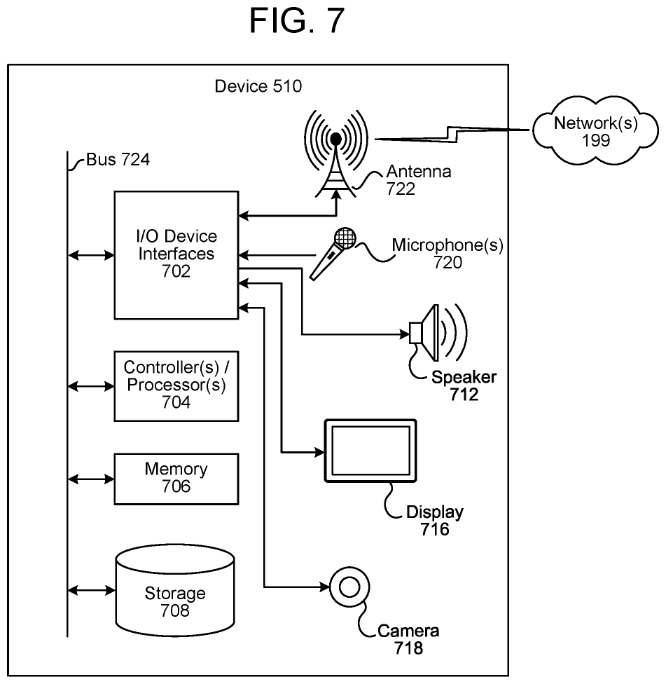

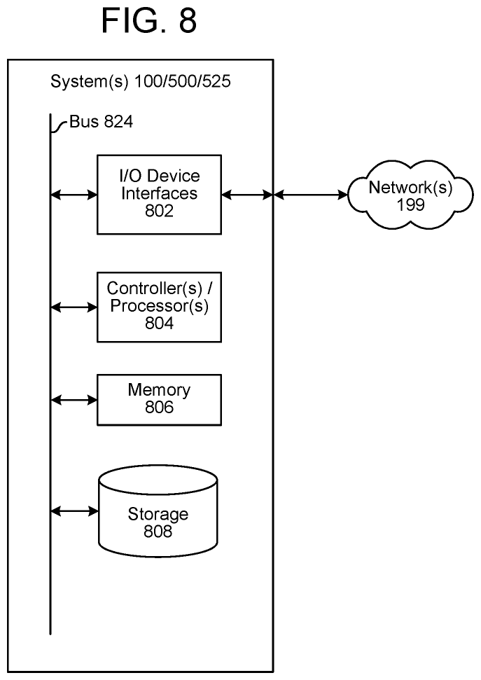

FIG. 1 is a conceptual diagram illustrating an example system 100 for generating synthetic data for ML models, according to embodiments of the present disclosure. In some embodiments, the system 100 includes a language model 120, a ML model 130, an output evaluation component 140 and an examples evaluation component 160. One or more components of the system 100 may be implemented using components shown in FIG. 8. In some embodiments, the system 100 may be implemented using components of a device, such as those shown in FIG. 7. Although the figures and discussion of the present disclosure illustrate certain steps in a particular order, the steps described may be performed in a different order (as well as certain steps removed or added) without departing from the present disclosure.

As shown in FIG. 1, the language model 120 may receive (step 1) prompt data 112. The prompt data 112 may include a task 114 and examples 115. The task 114 and the examples 115 may be represented in natural language and may be, in some embodiments, text data. The task 114 may be an instruction to the language model 120 to perform the indicated task. For example, the task 114 may be “Generate a request for an image of a family” or “Generate a children's story theme about an animal.”

The examples 115 may include multiple individual examples 116. In some embodiments, the examples 115 may include a preconfigured number of examples 116 (e.g., four examples, five examples, 10 examples, etc.). In some embodiments, the examples 115 is an ordered list of examples 116. For example, the ordered list of examples may be:

{
First example: “image with a woman and a man” (example 116a)
Second example: “image with two people and one or more children”
(example 116b)
Third example: “image with a dog and two persons” (example 116c)
Fourth example: “image with older persons and younger persons”
(example 116d)
}

As another example, the ordered list of examples may be:

{
First example: “story about a lost dog who finds its family” (example
116a)
Second example: “story about a horse and a child learning to ride the
horse” (example 116b)
Third example: “story about a duck and ducklings” (example 116c)
Fourth example: “story about a lion and a lion cub” (example 116d)
}

The examples 116 may be, in some embodiments, more description, i.e., include more information. In some cases, the language model 120 may generate better outputs when the examples 116 include a certain amount of information (e.g., a more descriptive example). The prompt data 112 may be user-generated, for example, by a model developer/engineer. The prompt data 112 may be generated based on updated examples determined by the system 100 as described in relation to FIG. 1.

Language modeling is the use of various statistical and probabilistic techniques to determine the probability of a given sequence of words occurring in a sentence. Language models analyze bodies of text data to provide a basis for their word predictions. The language model 120 may be a generative model. In some embodiments, the language model 120 may be a large language model (LLM). A LLM is an advanced artificial intelligence system designed to process, understand, and generate human-like text based on massive amounts of data. An LLM model may be built using deep learning techniques, such as neural networks, and may be trained on extensive datasets that include text (or other type of data) from a broad range of sources, such as books and websites, for natural language processing. An LLM uses an expansive training dataset, as compared to a language model, and can include a large number of parameters (in the range of billions), hence, they are called “large” language models.

In some embodiments where the language model 120 is an LLM, the language model 120 may be a transformer-based seq2seq model involving an encoder-decoder architecture. In an encoder-decoder architecture, the encoder may produce a representation of an input text using a bidirectional encoding, and the decoder may use that representation to perform some task. In some such embodiments, the language model 120 may be a multilingual (approximately) 20 billion parameter seq2seq model that is pre-trained on a combination of denoising and Causal Language Model (CLM) tasks in various languages (e.g., English, French, German, Arabic, Hindi, Italian, Japanese, Spanish, etc.), and the language model 120 may be pre-trained for approximately 1 trillion tokens. Being trained on CLM tasks, the language model 120 may be capable of in-context learning. An example of such a LLM is the Alexa Teacher Model (Alexa TM).

In other embodiments, where the language model 120 is an LLM, the language model 120 may be a decoder-only architecture. The decoder-only architecture may use left-to-right (unidirectional) encoding of the input text. An example of such a LLM is the Generative Pre-trained Transformer 3 (GPT-3) and other versions of GPT. GPT-3 has a capacity of (approximately) 175 billion machine learning parameters.

Other examples of LLMs include BigScience Large Open-science Open-access Multilingual Language Model (BLOOM), Language Model for Dialogue Applications model (LaMDA), Bard, Large Language Model Meta AI (LLaMA), Titan Foundational Model, etc.

In some embodiments, the system may include a machine learning model(s) other than the language model 120 that may be configured to perform similar functionality as described herein with respect to the language model 120. Such machine learning model(s) may receive text and/or other types of data as inputs, and may output text and/or other types of data. Such model(s) may be neural network based models, deep learning models, classifier models, autoregressive models, seq2seq models, etc.

The language model 120 may process the prompt data 112 and may output (step 2) machine-generated data 122 (e.g., a machine-generated input for a ML model, a machine-generated example, a synthetic example, etc.). The machine-generated data 122 may be a natural language response, and may, in some embodiments, be text data. The machine-generated data 122 may be an output based on the task 114 and the examples 115. The language model 120 may use in-context learning techniques with respect to the examples 115 and generate the output according to the task 114. For example, the machine-generated data 122 may be “an image with one man, one woman and one child.” As another example, the machine-generated data 122 may be “an image with one man and one dog.” As yet another example, the machine-generated data 122 may be “a story about a bear and a bear cub.” As yet another example, the machine-generated data 122 may be “a story about a shark attack.”

The ML model 130 may receive (step 3) the machine-generated data 122. The ML model 130 may be configured to perform at least the task 114. For example, the ML model 130 may be configured to generate images based on a text input (e.g., a text-to-image generation model). As another example, the ML model 130 may be configured to generate images that includes persons or animals (e.g., pet animals). As yet another example, the ML model 130 may be configured to generate text based on a text input (e.g., a text-to-text generation model). As yet another example, the ML model 130 may be configured to generate a story based on a text input including a story theme. In some embodiments, the ML model 130 may be a reference model, a test model, etc. that is other than a live/runtime model that may be used to process “live” inputs from, for example, a user, a system 500, etc.

The ML model 130 may output (step 4) model output 132 based on processing the machine-generated data 122; as such, the model output 132 corresponds to the machine-generated data 122. The model output 132 may be in the form of data that the ML model 130 is configured to generate. For example, the model output 132 may be image data representing one man, one woman and one child. As another example, the model output 132 may be image data representing one man and one dog. As yet another example, the model output 132 may be text data representing a story about a bear and a bear cub. As yet another example, the model output 132 may be text data representing a story about a shark attacking people at a beach.

The output evaluation component 140 may receive (step 5) the model output 132. In some embodiments, the output evaluation component 140 may also receive target output 144. The target output 144 may be provided by a user (e.g., a model developer/engineer) or a system component. The target output 144 may indicate an output that is expected from the ML model 122. The output evaluation component 140 may be configured to determine whether the model output 122 corresponds to the target output, which in turn also determines whether the machine-generated data 122 can cause the ML model 130 to generate an output corresponding to the target output 144.

The target output 144 may be an example output, for example, an example image, an example story, etc. In other embodiments, the target output 144 may be a description of an expected output, may indicate parameters/conditions for the expected output, etc. For example, the target output 144 may indicate “a family is at least two adults and a child”, “a family is at least one adult and a child”, etc. As another example, the target output 144 may indicate “a children's story is about at least one of the following animals: [list of animals]”.

In some embodiments, the output evaluation component 140 may include a ML model, such as a classifier 142 that may be configured to determine whether the model output 132 corresponds to the target output 144. In some embodiments, the classifier 142 may be specifically configured with training samples of the target output, and thus the classifier 142 may operate without the target output 144. For example, the classifier 142 may be trained to classify image inputs as representing a family or not. As another example, the classifier 142 may be trained to classify text inputs as representing a children's story or not. In other embodiments, the classifier 142 may be configured to process the target output 144 and an another input (the model output 132) to determine whether the other input corresponds to the target output 144.

In some embodiments, the output evaluation component 140 may use other techniques for evaluating the model output 132, such as, rules-based engine, statistical models, probabilities modes, other types of ML models (e.g., image processing models, text processing models, language models, etc.). For example, the output evaluation component 140 may use an image processing model to identify a number and type of persons and animals represented in the model output 132. As another example, the output evaluation component 140 may use a topic determination model to identify a theme of the story represented in the model output 132. As a further example, the output evaluation component 140 may use a rules-based engine to determine whether a number and type of persons and animals represented in the model output 132 satisfies a “family”, which may be defined in the target output 144.

The output evaluation component 140 may output (step 6) model output feedback 150 based on processing the model output 132 and (optionally) the target output 144. The model output feedback 150 may indicate whether or not the model output 132 corresponds to the target output 144. In some embodiments, the model output feedback 150 includes a Boolean value indicating whether the model output 132 corresponds to the target output 144 (e.g., true/false, 0/1, yes/no, etc.). In some embodiments, the model output feedback 150 includes a value indicating a likelihood, a probability, etc. of whether the model output 132 corresponds to the target output 144.

The examples evaluation component 160 may receive (step 7) the model output feedback 150. The examples evaluation component 160 may also receive the machine-generated data 122 and the examples 115. The examples evaluation component 160 may be configured to generate a new set of examples (e.g., updated examples 162), which may include the machine-generated data 122. The examples evaluation component 160 may determine (step 8) the updated examples 162 to include one or more of the examples 115 and the machine-generated data 122. The examples evaluation component 160 may include the machine-generated data 122 in the updated examples 162 if the model output 132 corresponds to the target output 144, as indicated by the model output feedback 150. In some embodiments, the updated examples 162 is an ordered list of the examples 164.

In some embodiments, the examples 162 may include all but one of the examples 116. The examples evaluation component 160 may implement one or more techniques for determining which example 116 to remove. In other embodiments, the examples 162 may include the ordered list of examples 116 and the machine-generated data 122 appended to the end of the ordered list of examples 116.

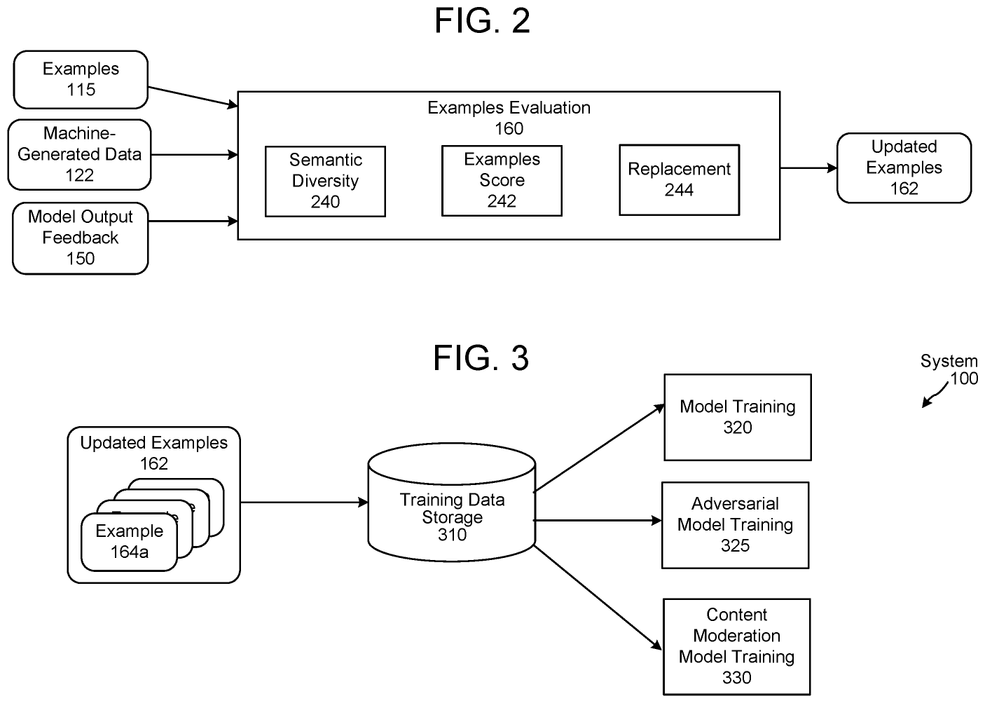

FIG. 2 illustrates example components of the examples evaluation component 160. As shown in FIG. 2, the examples evaluation component 160 may include, in some embodiments, a semantic diversity component 240, an examples score component 242 and a replacement component 244.

The semantic diversity component 240 may be configured to include the machine-generated data 122 and one or more of the examples 116 in the updated examples 162 based on the generated list being semantically diverse. The semantic diversity component 240 may add the machine-generated data 122 to the examples 115 if it improves the semantic diversity of the list. The semantic diversity component 240 may remove one of the examples 115 that least improves (or impairs) the semantic diversity of the list. A semantically diverse list may include example inputs with varying words and with low/minimal overlap in same words among the examples. Diversity in the examples can ensure that the ML model 130, trained using such examples, is more robust and is capable of handling variety of inputs.

In some embodiments, the semantic diversity component 240 may calculate a pair-wise semantic difference between each of the items of a list, and then determine an average (e.g., a mean, a median, a mode, etc.) of the pair-wise semantic differences to generate a single value representing a semantic diversity of the list. The pair-wise semantic difference may be determined using a cosine similarity function to determine variations between words of two example inputs. The semantic diversity component 240 may determine a semantic diversity value for a first list that is the examples 115; thus determining a first semantic difference between the examples 116a and 116b, a second semantic difference between the examples 116a and 116c, a third semantic difference between the examples 116a and 116d, a fourth semantic difference between the examples 116b and 116c, a fifth semantic difference between the examples 116b and 116d, and a sixth semantic difference between the examples 116c and 116d, and then determining an average of the first through sixth semantic differences, where the average is the semantic diversity value for the list of examples 115. In a similar manner, the semantic diversity component 240 may determine a semantic diversity value for a second list that has one of the examples 116 replaced with the machine-generated data 122, and then for a third list that has a different one of the examples 116 replaced with the machine-generated data 122, and so on. The semantic diversity component 240 may then compare the determined semantic diversity values for the individual lists, and then select the list with the best (highest) semantic diversity value. In some cases, the selected list includes the machine-generated data 122. In other cases, the selected list may not include the machine-generated data 122. The selected list is then outputted as the updated examples 162. In this manner, the updated examples 162 may be a semantically diverse set of examples.

The examples score component 242 may be configured to include the machine-generated data 122 and one or more of the examples 116 in the updated examples 162 based on a corresponding score. Each of the examples 116 and the machine-generated data 122 may be associated with a score, where the score represents a likelihood of the example 116/input 122 causing generation of a model output 132 that corresponds to the target output 144. The score for the examples 116 may be provided by a user (e.g., a model developer/engineer). In some embodiments, the examples score component 242 may determine the score based on the value, included in the model output feedback 150, corresponding to the example 116/input 122. For example, the score for the machine-generated data 122 may be the value representing a likelihood of the model output 132 corresponding to the target output 144. The examples score component 242 may determine the updated examples 162 to include items of the examples 116 and the machine-generated data 122 with the highest/best score. In some examples, the examples score component 242 may replace the example 116 associated with the lowest score with the machine-generated data 122, if the score for the machine-generated data 122 is higher than the example 116 being replaced. In this manner, the updated examples 162 may be a set of examples that are most effective in causing generation of the target output 144.

The replacement component 244 may implement a First-In-First-Out (FIFO) or a Last-In-First-Out (LIFO) technique to remove an example 116, from the examples 115, and to add the machine-generated data 122 as an example 164 to generate the updated examples 162.

In some embodiments, the replacement component 244 may consider the examples 115 as an ordered list and may update them on a FIFO basis. The machine-generated data 122, which resulted in the model output 132 that corresponds to the target output 144, may be placed at the end of the list and the first example 116a may be removed to generate the updated examples 162. For example, the updated examples 162, which may include four examples, may include the second example 116b (as the first example 164a), the third example 116c (as the second example 164b), the fourth example 116d (as the third example 164c), and the machine-generated data 122 (as the fourth example 164d).

In some embodiments, the replacement component 244 may consider the examples 115 as an ordered list and may update them on a LIFO basis. The machine-generated data 122, which resulted in the model output 132 that corresponds to the target output 144, may be placed at the top of the list replacing the first example 116a. For example, the updated examples 162, which may include four examples, may include the machine-generated data 122 (as the first example 164a), the second example 116b (as the second example 164b), the third example 116c (as the third example 164c), and the fourth example 116d (as the fourth example 164d).

In this manner, as described in relation to FIG. 1, the system 100 may generate examples 162 that when inputted to the ML model 130 (or another ML model that is configured for the same or similar task as the ML model 130) cause generation of the target output 144. In some embodiments, the updated examples 162 may be processed as the examples 115 and may be further updated (to generated a new list) with another machine-generated input if the conditions described in relation to FIG. 1 (e.g., steps 6 to 8) are satisfied. For example, second prompt data 112b may be generated including the task 114 and the updated examples 162. Based on processing the prompt data 112b (as described in relation to FIG. 1), second machine-generated data 122b may be added to the updated examples 162. In some cases, an original example (that is provided by a user) may be removed to add the second machine-generated data 122b. The process of FIG. 1 may be repeated until the updated examples 162 includes machine-generated data and no original/user-provided examples. In other cases, the process of FIG. 1 may be repeated until the updated examples 162 is semantically diverse. In yet other cases, the process of FIG. 1 may be repeated until the individual examples 164 are associated with a certain score (e.g., a score above a certain threshold value).

In some embodiments, the process of FIG. 1 may be repeated to generate additional machine-generated data based on an outcome of a training process. For example, additional machine-generated data may be determined if additional training data is needed, if training data does not result in a ML model that satisfies certain conditions (e.g., performance metrics), etc.

FIG. 3 illustrates how the updated examples 162 may be used as training data. The updated examples 162 may be stored in a training data storage 310, which store other data, such as additional examples (e.g., positive examples for a task, negative examples for a task, etc.) for a task. In some embodiments, the training data storage 310 may also store the corresponding model output for the individual examples 164. For example, for the machine-generated data 122, the training data storage 310 may store the model output 132 as associated with the machine-generated data 122. The pair of examples and model outputs may be used as training data. The training data storage 310 may be used to perform one or more training techniques. In example embodiments, the training data storage 310 may be used by a model training component 320 to update/retrain the ML model 130 or to configure/train another ML model.

In other example embodiments, the training data storage 310 may be used by an adversarial training component 325 to perform adversarial training of the ML model 130 or another ML model. In such embodiments, the updated examples 162 may be generated as adversarial examples (or negative examples for a task) that may be used to fool/confuse the ML model 130 in generating outputs that are not part of the configured task.

In yet other embodiments, the training data storage 310 may be used by a content moderation model training component 330 to configure/train a separate ML model (other than the ML model 130) that may “moderate” content/output generated by the ML model 130. A content moderation model may process an output of the ML model 130 to determine whether the output satisfies a condition(s), such as the output corresponds to a task that the ML model 130 is trained for. In other examples, the content moderation model may determine whether the output includes biased information (e.g., bias towards a protected class), harmful information (e.g., violence-related content, harmful content), profanity, content based on model hallucinations, etc. A model hallucination refers to when a model (e.g., a language model) generates a confident response that is not grounded in any of its training data. For example, the model may generate a response including a random number, which is not an accurate response to an input prompt, and then the model may continue to falsely represent that the random number is an accurate response to future input prompts.

In yet other embodiments, the training data storage 310 may be used to evaluate a ML model's performance. For example, performance metrics, such as recall and precision metrics, accuracy metrics, latency metrics, etc. may be determined by causing the ML model to process the data included in the training data storage 310.

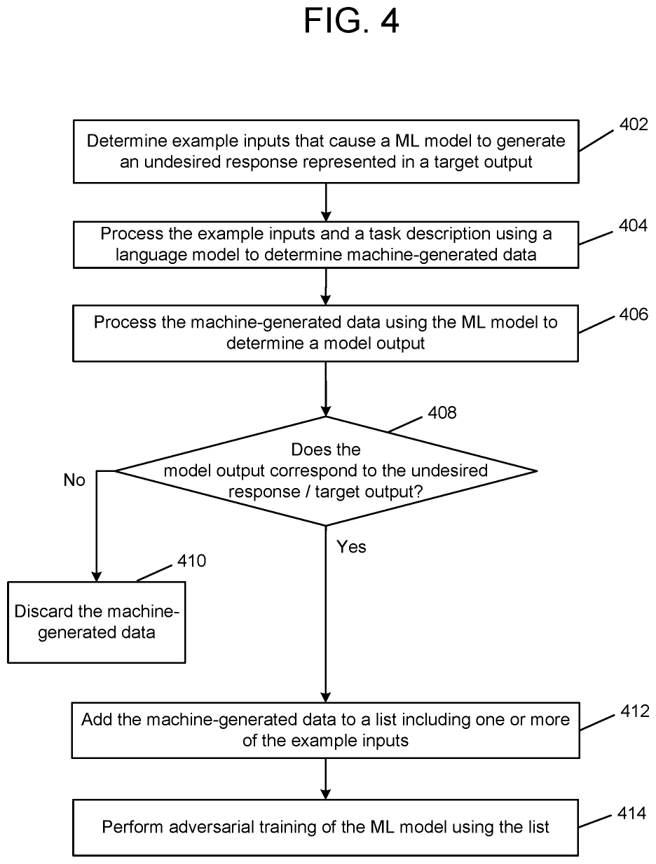

FIG. 4 is a flowchart illustrating an example process that may be performed by the system 100 to generate synthetic data for adversarial training of a ML model. At a step 402, the system 100 may determine example inputs (e.g., example inputs 116) that cause a ML model (e.g., ML model 130) to generate an undesired response represented in a target output (e.g., target output 144). In some examples, the undesired response may be unsafe content or toxic content that is to be prevented from being presented to a user. Unsafe or toxic content may be offensive, insulting, threatening, violent, harmful, or might otherwise cause anxiety. In some examples, the undesired response may be a biased response towards a particular group of people. In yet other examples, the undesired response may be a response that a model developer/engineer does not want the ML model to output. For example, a ML model configured to generate images of a family may be further configured to not generate an image that only includes one person and one pet (i.e. an undesired response). As another example, a ML model configured to generate a children's story may be further configured to not generate a story that includes certain types of animals that a child may find scary (e.g., a shark). The example inputs 116 may be provided by a user (e.g., a model developer/engineer, system administrator, etc.).

At a step 404, the system may process the example inputs and a task description (e.g., task 114) using a language model (e.g., language model 120) to determine a machine-generated input (e.g., machine-generated data 122). As described in relation to FIG. 1, the task 114 may be an instruction to the language model 120 to generate data according to the task description. For example, the task 114 may be “generate a request for an image of a family” or “generate a children's story theme” etc.

At a step 406, the system may process the machine-generated data 122 using the ML model 130 to determine a model output (e.g., model output 132). At a decision step 408, the system may determine whether the model output 132 corresponds to the undesired response represented in the target output 144. If the model output 132 does not correspond to the undesired response (for example, if the model output 132 does not include unsafe or toxic content, if the model output 132 does not include an output that the ML model is to be configured to not output, etc.), then the system, at a step 410, may discard the machine-generated data 122.

At the decision step 408, if the model output 132 corresponds to the undesired response, then at a step 412 the system may add the machine-generated data 122 to a list (e.g., updated example inputs 162) including one or more of the example inputs 116. In some embodiments, as described in relation to FIG. 1, the system may replace one of the example inputs 116 with the machine-generated data 122 to generate the updated list of examples 162. In some embodiments, the system may use a FIFO technique or a LIFO technique to perform the replacement. In some embodiments, the system may add the machine-generated input to the list based on the machine-generated data 122 improving a semantic diversity value of the list. In yet other embodiments, the system may add the machine-generated input to the list if a corresponding score (e.g., based on a likelihood of the model output 132 corresponding to the target output 144) is better than at least one of the scores corresponding to the example inputs 116.

At a step 414, the system may perform adversarial training of the ML model 130 (or another ML model) using the list (determined at the step 412). Using adversarial training, the ML model 130 may be trained to not generate outputs corresponding to the example inputs 162, which may include the machine-generated data 122. For example, the ML model 130 may be trained to not output unsafe or toxic content. As another example, the ML model 130 may be trained to not generate an image including only one person and one pet. As another example, the ML model 130 may be trained to not generate stories including scary animals.

In other embodiments, the list determined in the step 412 may be used to configure/train another ML model, which may be referred to as a content moderation model. The content moderation model may be configured to determine whether an output of the ML model 130 includes the undesired response (e.g., unsafe or toxic content, an output that the ML model 130 is not to generate, etc.).

The techniques described above may be used to generate training examples for configuring one or more of the components of a system 200 described below in detail. For example, the system 100 may be used to generate synthetic data representing a natural language input (e.g., text data) that may be processed using a TTS component 580 to generate synthesized speech.

The techniques described herein can be used to generate synthetic data for ML models that are discriminative models. The techniques can also be used to generate synthetic data for ML models that are configured for video generation tasks, music/audio generation tasks, speech generation tasks, avatar generation tasks, etc.

Automatic speech recognition (ASR) is a field of computer science, artificial intelligence, and linguistics concerned with transforming audio data associated with speech into text representative of that speech. Similarly, natural language understanding (NLU) is a field of computer science, artificial intelligence, and linguistics concerned with enabling computers to derive meaning from text input containing natural language. ASR and NLU are often used together as part of a speech processing system, sometimes referred to as a spoken language understanding (SLU) system. Natural Language Generation (NLG) includes enabling computers to generate output text or other data in words a human can understand, such as sentences or phrases. Text-to-speech (TTS) is a field of computer science concerning transforming textual and/or other data into audio data that is synthesized to resemble human speech. ASR, NLU, NLG, and TTS may be used together as part of a speech-processing/virtual assistant system.

The system may be configured to incorporate user permissions and may only perform activities disclosed herein if approved by a user. As such, the systems, devices, components, and techniques described herein would be typically configured to restrict processing where appropriate and only process user information in a manner that ensures compliance with all appropriate laws, regulations, standards, and the like. The system and techniques can be implemented on a geographic basis to ensure compliance with laws in various jurisdictions and entities in which the components of the system and/or user are located.

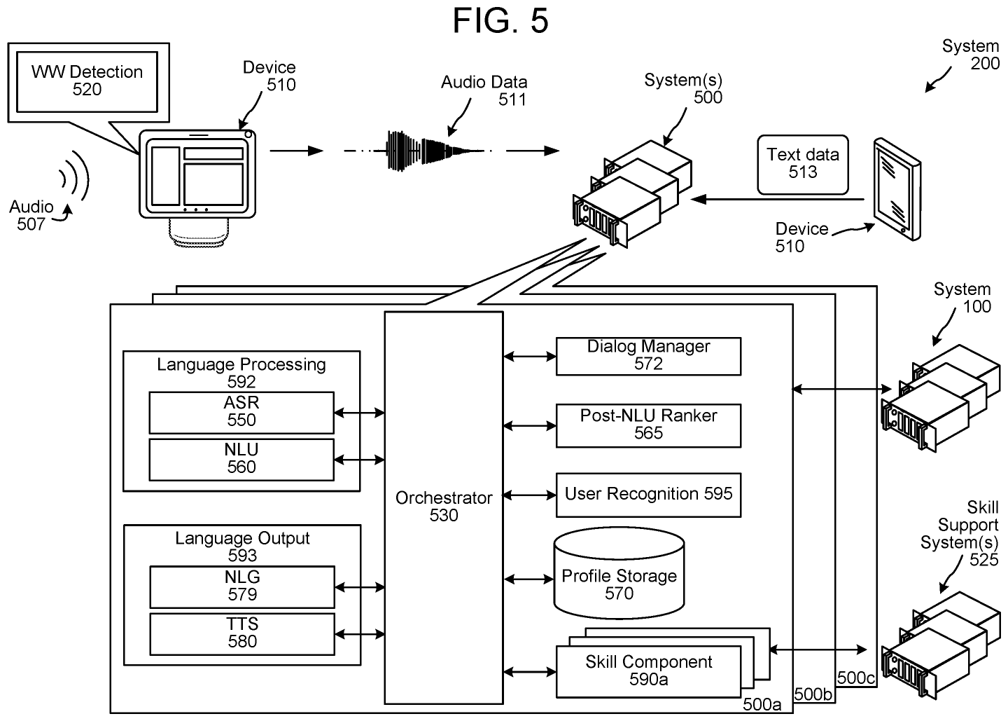

FIG. 5 is a conceptual diagram illustrating a virtual assistant system 200 for natural language processing, according to embodiments of the present disclosure. As shown in FIG. 5, the virtual assistant system 200 may include a voice-enabled device 510, a natural language processing system 500 (abbreviated “system 500”), and one or more skill support systems 525 connected across one or more networks 199. The system 200 may be in communication with the system 100 (described above in relation to FIGS. 1-4). As described herein, the system 100 may be used to generate synthetic data for various components of the system 500.

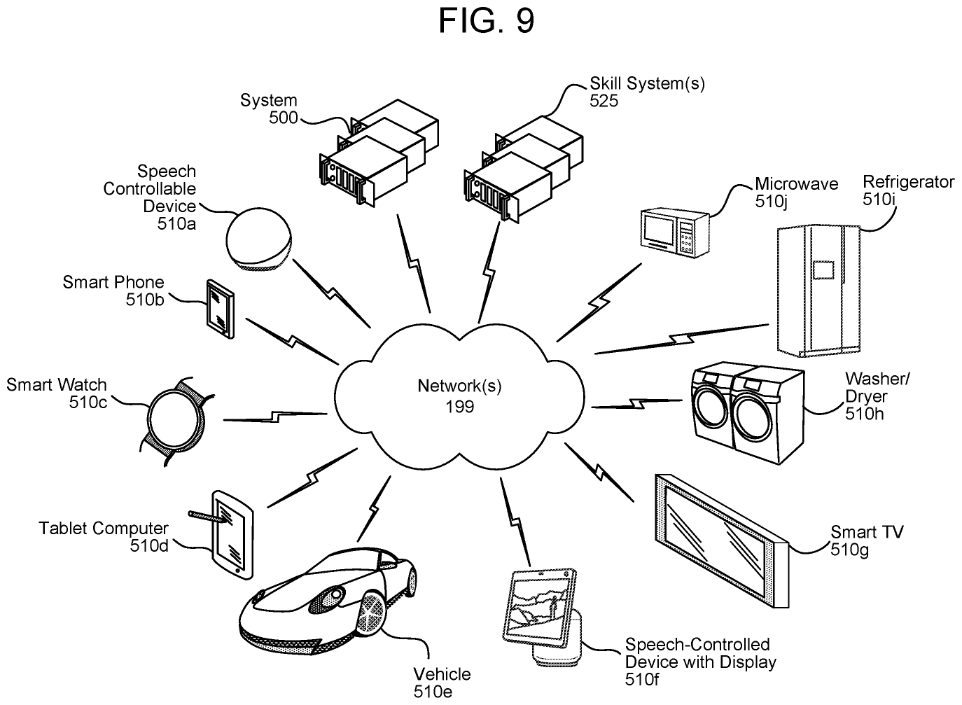

The device 510 may receive audio 507 corresponding to a spoken natural language input originating from a user. The device 510 may process audio following detection of a wakeword. The device 510 may generate audio data 511 corresponding to the audio 507, and may send the audio data to the system 500. The device 510 may send the audio data to the system 500 via an application that is installed on the device 510 and associated with the system 500. An example of such an application is the Amazon Alexa application that may be installed on a smart phone, tablet, or the like. In some implementations, the device 510 may receive text data 513 corresponding to a natural language input originating from the user, and send the text data to the system 500. The device 510 may also receive output data from the system 500, and generate a synthesized speech output. The device 510 may include a camera for capturing image and/or video data for processing by the system 500. Examples of various devices 510 are further illustrated in FIG. 9. The system 500 may be remote system such as a group of computing components located geographically remote from device 510 but accessible via network 199 (for example, servers accessible via the internet). The system 500 may also include a remote system that is physically separate from device 510 but located geographically close to device 510 and accessible via network 199 (for example a home server located in a same residence as device 510). System 500 may also include some combination thereof, for example where certain components/operations are performed via a home server(s) and others are performed via a geographically remote server(s).

The system 200 may operate using various components as described in FIG. 5. The various components may be located on same or different physical devices. Communication between various components may occur directly or across a network(s) 199. The device 510 may include audio capture component(s), such as a microphone or array of microphones of a device 510, captures audio 507 and creates corresponding audio data. Once speech is detected in audio data representing the audio 507, the device 510 may determine if the speech is directed at the device 510/system 500. In at least some embodiments, such determination may be made using a wakeword detection component 520. The wakeword detection component 520 may be configured to detect various wakewords. In at least some examples, each wakeword may correspond to a name of a different digital assistant. An example wakeword/digital assistant name is “Alexa.” In another example, input to the system may be in form of text data 513, for example as a result of a user typing an input into a user interface of device 510. Other input forms may include indication that the user has pressed a physical or virtual button on device 510, the user has made a gesture, etc. The device 510 may also capture images using camera(s) 718 of the device 510 and may send image data representing those image(s) to the system 500. The image data may include raw image data or image data processed by the device 510 before sending to the system 500. The image data may be used in various manners by different components of the system to perform operations such as determining whether a user is directing an utterance to the system, interpreting a user command, responding to a user command, etc.

The wakeword detector 520 of the device 510 may process the audio data, representing the audio 507, to determine whether speech is represented therein. The device 510 may use various techniques to determine whether the audio data includes speech. In some examples, the device 510 may apply voice-activity detection (VAD) techniques. Such techniques may determine whether speech is present in audio data based on various quantitative aspects of the audio data, such as the spectral slope between one or more frames of the audio data; the energy levels of the audio data in one or more spectral bands; the signal-to-noise ratios of the audio data in one or more spectral bands; or other quantitative aspects. In other examples, the device 510 may implement a classifier configured to distinguish speech from background noise. The classifier may be implemented by techniques such as linear classifiers, support vector machines, and decision trees. In still other examples, the device 510 may apply hidden Markov model (HMM) or Gaussian mixture model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

Wakeword detection is typically performed without performing linguistic analysis, textual analysis, or semantic analysis. Instead, the audio data, representing the audio 507, is analyzed to determine if specific characteristics of the audio data match preconfigured acoustic waveforms, audio signatures, or other data corresponding to a wakeword.

Thus, the wakeword detection component 520 may compare audio data to stored data to detect a wakeword. One approach for wakeword detection applies general large vocabulary continuous speech recognition (LVCSR) systems to decode audio signals, with wakeword searching being conducted in the resulting lattices or confusion networks. Another approach for wakeword detection builds HMMs for each wakeword and non-wakeword speech signals, respectively. The non-wakeword speech includes other spoken words, background noise, etc. There can be one or more HMMs built to model the non-wakeword speech characteristics, which are named filler models. Viterbi decoding is used to search the best path in the decoding graph, and the decoding output is further processed to make the decision on wakeword presence. This approach can be extended to include discriminative information by incorporating a hybrid DNN-HMM decoding framework. In another example, the wakeword detection component 520 may be built on deep neural network (DNN)/recursive neural network (RNN) structures directly, without HMM being involved. Such an architecture may estimate the posteriors of wakewords with context data, either by stacking frames within a context window for DNN, or using RNN. Follow-on posterior threshold tuning or smoothing is applied for decision making. Other techniques for wakeword detection, such as those known in the art, may also be used.

Once the wakeword is detected by the wakeword detector 520 and/or input is detected by an input detector, the device 510 may “wake” and begin transmitting audio data 511, representing the audio 507, to the system(s) 500. The audio data 511 may include data corresponding to the wakeword; in other embodiments, the portion of the audio corresponding to the wakeword is removed by the device 510 prior to sending the audio data 511 to the system(s) 500. In the case of touch input detection or gesture based input detection, the audio data may not include a wakeword.

In some implementations, the system 200 may include more than one system 500. The systems 500 may respond to different wakewords and/or perform different categories of tasks. Each system 500 may be associated with its own wakeword such that speaking a certain wakeword results in audio data be sent to and processed by a particular system. For example, detection of the wakeword “Alexa” by the wakeword detector 520 may result in sending audio data to system 500a for processing while detection of the wakeword “Computer” by the wakeword detector may result in sending audio data to system 500b for processing. The system may have a separate wakeword and system for different skills/systems (e.g., “Dungeon Master” for a game play skill/system 500c) and/or such skills/systems may be coordinated by one or more skill(s) 590 of one or more systems 500.

Upon receipt by the system(s) 500, the audio data 511 may be sent to an orchestrator component 530. The orchestrator component 530 may include memory and logic that enables the orchestrator component 530 to transmit various pieces and forms of data to various components of the system, as well as perform other operations as described herein.

The orchestrator component 530 may send the audio data 511 to a language processing component 592. The language processing component 592 (sometimes also referred to as a spoken language understanding (SLU) component) includes an automatic speech recognition (ASR) component 550 and a natural language understanding (NLU) component 560. The ASR component 550 may transcribe the audio data 511 into text data. The text data output by the ASR component 550 represents one or more than one (e.g., in the form of an N-best list) ASR hypotheses representing speech represented in the audio data 511. The ASR component 550 interprets the speech in the audio data 511 based on a similarity between the audio data 511 and pre-established language models. For example, the ASR component 550 may compare the audio data 511 with models for sounds (e.g., acoustic units such as phonemes, senons, phones, etc.) and sequences of sounds to identify words that match the sequence of sounds of the speech represented in the audio data 511. The ASR component 550 sends the text data generated thereby to an NLU component 560, via, in some embodiments, the orchestrator component 530. The text data sent from the ASR component 550 to the NLU component 560 may include a single top-scoring ASR hypothesis or may include an N-best list including multiple top-scoring ASR hypotheses. An N-best list may additionally include a respective score associated with each ASR hypothesis represented therein. The ASR component 550 is described in greater detail below with regard to FIG. XXB.

The speech processing system 592 may further include a NLU component 560. The NLU component 560 may receive the text data from the ASR component. The NLU component 560 may attempts to make a semantic interpretation of the phrase(s) or statement(s) represented in the text data input therein by determining one or more meanings associated with the phrase(s) or statement(s) represented in the text data. The NLU component 560 may determine an intent representing an action that a user desires be performed and may determine information that allows a device (e.g., the device 510, the system(s) 500, a skill component 590, a skill system(s) 525, etc.) to execute the intent. For example, if the text data corresponds to “play the 5^{th} Symphony by Beethoven,” the NLU component 560 may determine an intent that the system output music and may identify “Beethoven” as an artist/composer and “5th Symphony” as the piece of music to be played. For further example, if the text data corresponds to “what is the weather,” the NLU component 560 may determine an intent that the system output weather information associated with a geographic location of the device 510. In another example, if the text data corresponds to “turn off the lights,” the NLU component 560 may determine an intent that the system turn off lights associated with the device 510 or the user. However, if the NLU component 560 is unable to resolve the entity—for example, because the entity is referred to by anaphora such as “this song” or “my next appointment”—the speech processing system 592 can send a decode request to another speech processing system 592 for information regarding the entity mention and/or other context related to the utterance. The speech processing system 592 may augment, correct, or base results data upon the audio data 511 as well as any data received from the other speech processing system 592.

The NLU component 560 may return NLU results data (which may include tagged text data, indicators of intent, etc.) back to the orchestrator 530. The orchestrator 530 may forward the NLU results data to a skill component(s) 590. If the NLU results data includes a single NLU hypothesis, the NLU component 560 and the orchestrator component 530 may direct the NLU results data to the skill component(s) 590 associated with the NLU hypothesis. If the NLU results data includes an N-best list of NLU hypotheses, the NLU component 560 and the orchestrator component 530 may direct the top scoring NLU hypothesis to a skill component(s) 590 associated with the top scoring NLU hypothesis. The system may also include a post-NLU ranker 565 which may incorporate other information to rank potential interpretations determined by the NLU component 560. The local device 510 may also include its own post-NLU ranker 665, which may operate similarly to the post-NLU ranker 565.

A skill component may be software running on the system(s) 500 that is akin to a software application. That is, a skill component 590 may enable the system(s) 500 to execute specific functionality in order to provide data or produce some other requested output. As used herein, a “skill component” may refer to software that may be placed on a machine or a virtual machine (e.g., software that may be launched in a virtual instance when called). A skill component may be software customized to perform one or more actions as indicated by a business entity, device manufacturer, user, etc. What is described herein as a skill component may be referred to using many different terms, such as an action, bot, app, or the like. The system(s) 500 may be configured with more than one skill component 590. For example, a weather service skill component may enable the system(s) 500 to provide weather information, a car service skill component may enable the system(s) 500 to book a trip with respect to a taxi or ride sharing service, a restaurant skill component may enable the system(s) 500 to order a pizza with respect to the restaurant's online ordering system, etc. A skill component 590 may operate in conjunction between the system(s) 500 and other devices, such as the device 510, in order to complete certain functions. Inputs to a skill component 590 may come from speech processing interactions or through other interactions or input sources. A skill component 590 may include hardware, software, firmware, or the like that may be dedicated to a particular skill component 590 or shared among different skill components 590.

A skill support system(s) 525 may communicate with a skill component(s) 590 within the system(s) 500 and/or directly with the orchestrator component 530 or with other components. A skill support system(s) 525 may be configured to perform one or more actions. An ability to perform such action(s) may sometimes be referred to as a “skill.” That is, a skill may enable a skill support system(s) 525 to execute specific functionality in order to provide data or perform some other action requested by a user. For example, a weather service skill may enable a skill support system(s) 525 to provide weather information to the system(s) 500, a car service skill may enable a skill support system(s) 525 to book a trip with respect to a taxi or ride sharing service, an order pizza skill may enable a skill support system(s) 525 to order a pizza with respect to a restaurant's online ordering system, etc. Additional types of skills include home automation skills (e.g., skills that enable a user to control home devices such as lights, door locks, cameras, thermostats, etc.), entertainment device skills (e.g., skills that enable a user to control entertainment devices such as smart televisions), video skills, flash briefing skills, as well as custom skills that are not associated with any pre-configured type of skill.

The system(s) 500 may be configured with a skill component 590 dedicated to interacting with the skill support system(s) 525. Unless expressly stated otherwise, reference to a skill, skill device, or skill component may include a skill component 590 operated by the system(s) 500 and/or skill operated by the skill support system(s) 525. Moreover, the functionality described herein as a skill or skill may be referred to using many different terms, such as an action, bot, app, or the like. The skill 590 and or skill support system(s) 525 may return output data to the orchestrator 530.

Dialog processing is a field of computer science that involves communication between a computing system and a human via text, audio, and/or other forms of communication. While some dialog processing involves only simple generation of a response given only a most recent input from a user (i.e., single-turn dialog), more complicated dialog processing involves determining and optionally acting on one or more goals expressed by the user over multiple turns of dialog, such as making a restaurant reservation and/or booking an airline ticket. These multi-turn “goal-oriented” dialog systems typically need to recognize, retain, and use information collected during more than one input during a back-and-forth or “multi-turn” interaction with the user.

The system(s) 200 may include a dialog manager component 572 that manages and/or tracks a dialog between a user and a device. As used herein, a “dialog” may refer to data transmissions (such as relating to multiple user inputs and system 200 outputs) between the system 200 and a user (e.g., through device(s) 510) that all relate to a single “conversation” between the system and the user that may have originated with a single user input initiating the dialog. Thus, the data transmissions of a dialog may be associated with a same dialog identifier, which may be used by components of the overall system 200 to track information across the dialog. Subsequent user inputs of the same dialog may or may not start with speaking of a wakeword. Each natural language input of a dialog may be associated with a different natural language input identifier such that multiple natural language input identifiers may be associated with a single dialog identifier. Further, other non-natural language inputs (e.g., image data, gestures, button presses, etc.) may relate to a particular dialog depending on the context of the inputs. For example, a user may open a dialog with the system 200 to request a food delivery in a spoken utterance and the system may respond by displaying images of food available for order and the user may speak a response (e.g., “item 1” or “that one”) or may gesture a response (e.g., point to an item on the screen or give a thumbs-up) or may touch the screen on the desired item to be selected. Non-speech inputs (e.g., gestures, screen touches, etc.) may be part of the dialog and the data associated therewith may be associated with the dialog identifier of the dialog.

The dialog manager component 572 may associate a dialog session identifier with the dialog upon identifying that the user is engaging in a dialog with the user. The dialog manager component 572 may track a user input and the corresponding system generated response to the user input as a turn. The dialog session identifier may correspond to multiple turns of user input and corresponding system generated response. The dialog manager component 572 may transmit data identified by the dialog session identifier directly to the orchestrator component 530 or other component. Depending on system configuration the dialog manager 572 may determine the appropriate system generated response to give to a particular utterance or user input of a turn. Or creation of the system generated response may be managed by another component of the system (e.g., the language output component 593, NLG 579, orchestrator 530, etc.) while the dialog manager 572 selects the appropriate responses. Alternatively, another component of the system(s) 500 may select responses using techniques discussed herein. The text of a system generated response may be sent to a TTS component 580 for creation of audio data corresponding to the response. The audio data may then be sent to a user device (e.g., device 510) for ultimate output to the user. Alternatively (or in addition) a dialog response may be returned in text or some other form.

The dialog manager 572 may receive the ASR hypothesis/hypotheses (i.e., text data) and make a semantic interpretation of the phrase(s) or statement(s) represented therein. That is, the dialog manager 572 determines one or more meanings associated with the phrase(s) or statement(s) represented in the text data based on words represented in the text data. The dialog manager 572 determines a goal corresponding to an action that a user desires be performed as well as pieces of the text data that allow a device (e.g., the device 510, the system(s) 500, a skill 590, a skill system(s) 525, etc.) to execute the intent. If, for example, the text data corresponds to “what is the weather,” the dialog manager 572 may determine that that the system(s) 500 is to output weather information associated with a geographic location of the device 510. In another example, if the text data corresponds to “turn off the lights,” the dialog manager 572 may determine that the system(s) 500 is to turn off lights associated with the device(s) 510 or the user(s) 5.

The dialog manager 572 may send the results data to one or more skill(s) 590. If the results data includes a single hypothesis, the orchestrator component 530 may send the results data to the skill(s) 590 associated with the hypothesis. If the results data includes an N-best list of hypotheses, the orchestrator component 530 may send the top scoring hypothesis to a skill(s) 590 associated with the top scoring hypothesis.

The system 500 includes a language output component 593. The language output component 593 includes a natural language generation (NLG) component 579 and a text-to-speech (TTS) component 580. The NLG component 579 can generate text for purposes of TTS output to a user. For example the NLG component 579 may generate text corresponding to instructions corresponding to a particular action for the user to perform. The NLG component 579 may generate appropriate text for various outputs as described herein. The NLG component 579 may include one or more trained models configured to output text appropriate for a particular input. The text output by the NLG component 579 may become input for the TTS component 580. Alternatively or in addition, the TTS component 580 may receive text data from a skill 590 or other system component for output.

The NLG component 579 may include a trained model. The NLG component 579 generates text data from dialog data received by the dialog manager 572 such that the output text data has a natural feel and, in some embodiments, includes words and/or phrases specifically formatted for a requesting individual. The NLG may use templates to formulate responses. And/or the NLG system may include models trained from the various templates for forming the output text data. For example, the NLG system may analyze transcripts of local news programs, television shows, sporting events, or any other media program to obtain common components of a relevant language and/or region. As one illustrative example, the NLG system may analyze a transcription of a regional sports program to determine commonly used words or phrases for describing scores or other sporting news for a particular region. The NLG may further receive, as inputs, a dialog history, an indicator of a level of formality, and/or a command history or other user history such as the dialog history.

The NLG system may generate dialog data based on one or more response templates. Further continuing the example above, the NLG system may select a template in response to the question, “What is the weather currently like?” of the form: “The weather currently is $weather_information$.” The NLG system may analyze the logical form of the template to produce one or more textual responses including markups and annotations to familiarize the response that is generated. In some embodiments, the NLG system may determine which response is the most appropriate response to be selected. The selection may, therefore, be based on past responses, past questions, a level of formality, and/or any other feature, or any other combination thereof. Responsive audio data representing the response generated by the NLG system may then be generated using the text-to-speech component 580.

The TTS component 580 may generate audio data (e.g., synthesized speech) from text data using one or more different methods. Text data input to the TTS component 580 may come from a skill component 590, the orchestrator component 530, or another component of the system. In one method of synthesis called unit selection, the TTS component 580 matches text data against a database of recorded speech. The TTS component 580 selects matching units of recorded speech and concatenates the units together to form audio data. In another method of synthesis called parametric synthesis, the TTS component 580 varies parameters such as frequency, volume, and noise to create audio data including an artificial speech waveform. Parametric synthesis uses a computerized voice generator, sometimes called a vocoder.

The device 510 may include still image and/or video capture components such as a camera or cameras to capture one or more images. The device 510 may include circuitry for digitizing the images and/or video for transmission to the system(s) 500 as image data. The device 510 may further include circuitry for voice command-based control of the camera, allowing a user to request capture of image or video data. The device 510 may process the commands locally or send audio data 511 representing the commands to the system(s) 500 for processing, after which the system(s) 500 may return output data that can cause the device 510 to engage its camera.

The system(s) 500 may include a user recognition component 595 that recognizes one or more users using a variety of data. However, the disclosure is not limited thereto, and the device 510 may include a user recognition component 695 instead of and/or in addition to user recognition component 595 of the system(s) 500 without departing from the disclosure. User recognition component 695 operates similarly to user recognition component 595.

The user-recognition component 595 may take as input the audio data 511 and/or text data output by the ASR component 550. The user-recognition component 595 may perform user recognition by comparing audio characteristics in the audio data 511 to stored audio characteristics of users. The user-recognition component 595 may also perform user recognition by comparing biometric data (e.g., fingerprint data, iris data, etc.), received by the system in correlation with the present user input, to stored biometric data of users assuming user permission and previous authorization. The user-recognition component 595 may further perform user recognition by comparing image data (e.g., including a representation of at least a feature of a user), received by the system in correlation with the present user input, with stored image data including representations of features of different users. The user-recognition component 595 may perform additional user recognition processes, including those known in the art.

The user-recognition component 595 determines scores indicating whether user input originated from a particular user. For example, a first score may indicate a likelihood that the user input originated from a first user, a second score may indicate a likelihood that the user input originated from a second user, etc. The user-recognition component 595 also determines an overall confidence regarding the accuracy of user recognition operations.

Output of the user-recognition component 595 may include a single user identifier corresponding to the most likely user that originated the user input. Alternatively, output of the user-recognition component 595 may include an N-best list of user identifiers with respective scores indicating likelihoods of respective users originating the user input. The output of the user-recognition component 595 may be used to inform NLU processing as well as processing performed by other components of the system.

The system 200 (either on device 510, system 500, or a combination thereof) may include profile storage for storing a variety of information related to individual users, groups of users, devices, etc. that interact with the system. As used herein, a “profile” refers to a set of data associated with a user, group of users, device, etc. The data of a profile may include preferences specific to the user, device, etc.; input and output capabilities of the device; internet connectivity information; user bibliographic information; subscription information, as well as other information.

The profile storage 570 may include one or more user profiles, with each user profile being associated with a different user identifier/user profile identifier. Each user profile may include various user identifying data. Each user profile may also include data corresponding to preferences of the user. Each user profile may also include preferences of the user and/or one or more device identifiers, representing one or more devices of the user. For instance, the user account may include one or more IP addresses, MAC addresses, and/or device identifiers, such as a serial number, of each additional electronic device associated with the identified user account. When a user logs into to an application installed on a device 510, the user profile (associated with the presented login information) may be updated to include information about the device 510, for example with an indication that the device is currently in use. Each user profile may include identifiers of skills that the user has enabled. When a user enables a skill, the user is providing the system 500 with permission to allow the skill to execute with respect to the user's natural language user inputs. If a user does not enable a skill, the system 500 may not invoke the skill to execute with respect to the user's natural language user inputs.

The profile storage 570 may include one or more group profiles. Each group profile may be associated with a different group identifier. A group profile may be specific to a group of users. That is, a group profile may be associated with two or more individual user profiles. For example, a group profile may be a household profile that is associated with user profiles associated with multiple users of a single household. A group profile may include preferences shared by all the user profiles associated therewith. Each user profile associated with a group profile may additionally include preferences specific to the user associated therewith. That is, each user profile may include preferences unique from one or more other user profiles associated with the same group profile. A user profile may be a stand-alone profile or may be associated with a group profile.

The profile storage 570 may include one or more device profiles. Each device profile may be associated with a different device identifier. Each device profile may include various device identifying information. Each device profile may also include one or more user identifiers, representing one or more users associated with the device. For example, a household device's profile may include the user identifiers of users of the household.

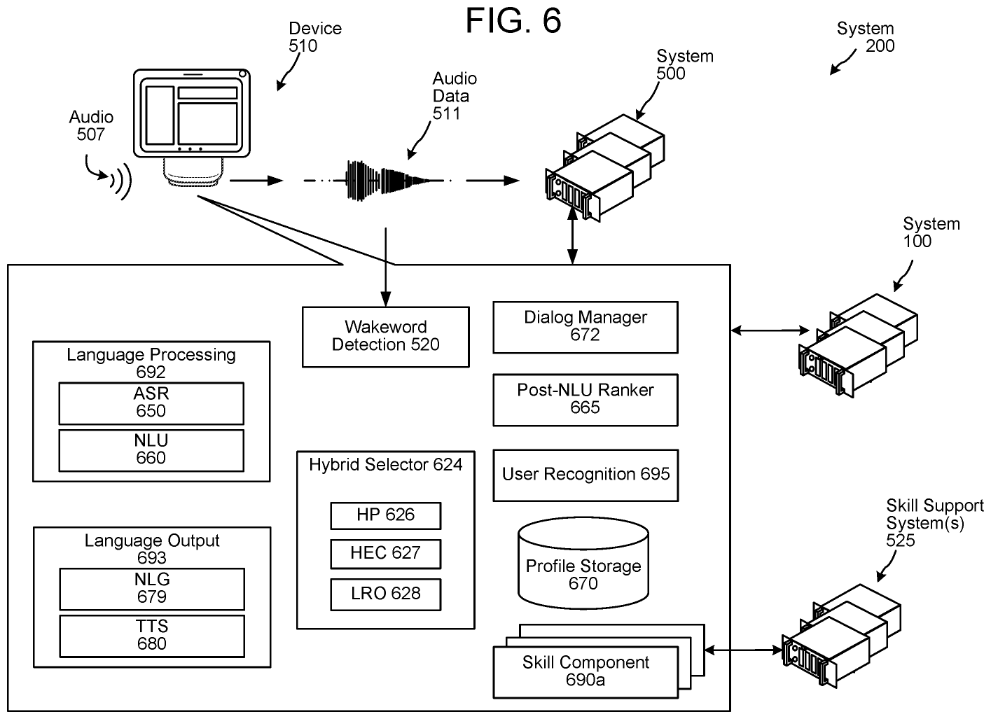

Although the components of FIG. 5 may be illustrated as part of system(s) 500, device 510, or otherwise, the components may be arranged in other device(s) (such as in device 510 if illustrated in system(s) 500 or vice-versa, or in other device(s) altogether) without departing from the disclosure. FIG. 6 illustrates such a configured device 510.

In at least some embodiments, the system 500 may receive the audio data 511 from the device 510, to recognize speech corresponding to a spoken input in the received audio data 511, and to perform functions in response to the recognized speech. In at least some embodiments, these functions involve sending directives (e.g., commands), from the system 500 to the device 510 (and/or other devices 510) to cause the device 510 to perform an action, such as output an audible response to the spoken input via a loudspeaker(s), and/or control secondary devices in the environment by sending a control command to the secondary devices.

Thus, when the device 510 is able to communicate with the system 500 over the network(s) 199, some or all of the functions capable of being performed by the system 500 may be performed by sending one or more directives over the network(s) 199 to the device 510, which, in turn, may process the directive(s) and perform one or more corresponding actions. For example, the system 500, using a remote directive that is included in response data (e.g., a remote response), may instruct the device 510 to output an audible response (e.g., using TTS processing performed by an on-device TTS component 680) to a user's question via a loudspeaker(s) of (or otherwise associated with) the device 510, to output content (e.g., music) via the loudspeaker(s) of (or otherwise associated with) the device 510, to display content on a display of (or otherwise associated with) the device 510, and/or to send a directive to a secondary device (e.g., a directive to turn on a smart light). It is to be appreciated that the system 500 may be configured to provide other functions in addition to those discussed herein, such as, without limitation, providing step-by-step directions for navigating from an origin location to a destination location, conducting an electronic commerce transaction on behalf of the user as part of a shopping function, establishing a communication session (e.g., a video call) between the user and another user, and so on.

As noted with respect to FIG. 5, the device 510 may include a wakeword detection component 520 configured to compare the audio data 511 to stored models used to detect a wakeword (e.g., “Alexa”) that indicates to the device 510 that the audio data 511 is to be processed for determining NLU output data (e.g., slot data that corresponds to a named entity, label data, and/or intent data, etc.). In at least some embodiments, a hybrid selector 624, of the device 510, may send the audio data 511 to the wakeword detection component 520. If the wakeword detection component 520 detects a wakeword in the audio data 511, the wakeword detection component 520 may send an indication of such detection to the hybrid selector 624. In response to receiving the indication, the hybrid selector 624 may send the audio data 511 to the system 500 and/or the ASR component 650. The wakeword detection component 520 may also send an indication, to the hybrid selector 624, representing a wakeword was not detected. In response to receiving such an indication, the hybrid selector 624 may refrain from sending the audio data 511 to the system 500, and may prevent the ASR component 650 from further processing the audio data 511. In this situation, the audio data 511 can be discarded.

The device 510 may conduct its own speech processing using on-device language processing components, such as an SLU/language processing component 692 (which may include an ASR component 650 and an NLU 660), similar to the manner discussed herein with respect to the SLU component 592 (or ASR component 550 and the NLU component 560) of the system 500. Language processing component 692 may operate similarly to language processing component 592, ASR component 650 may operate similarly to ASR component 550 and NLU component 660 may operate similarly to NLU component 560. The device 510 may also internally include, or otherwise have access to, other components such as one or more skill components 690 capable of executing commands based on NLU output data or other results determined by the device 510/system 500 (which may operate similarly to skill components 590), a user recognition component 695 (configured to process in a similar manner to that discussed herein with respect to the user recognition component 595 of the system 500), profile storage 670 (configured to store similar profile data to that discussed herein with respect to the profile storage 570 of the system 500), or other components. In at least some embodiments, the profile storage 670 may only store profile data for a user or group of users specifically associated with the device 510. Similar to as described above with respect to skill component 590, a skill component 690 may communicate with a skill system(s) 525. The device 510 may also have its own language output component 693 which may include NLG component 679 and TTS component 680. Language output component 693 may operate similarly to language output component 593, NLG component 679 may operate similarly to NLG component 579 and TTS component 680 may operate similarly to TTS component 580.

In at least some embodiments, the on-device language processing components may not have the same capabilities as the language processing components of the system 500. For example, the on-device language processing components may be configured to handle only a subset of the natural language user inputs that may be handled by the system 500. For example, such subset of natural language user inputs may correspond to local-type natural language user inputs, such as those controlling devices or components associated with a user's home. In such circumstances the on-device language processing components may be able to more quickly interpret and respond to a local-type natural language user input, for example, than processing that involves the system 500. If the device 510 attempts to process a natural language user input for which the on-device language processing components are not necessarily best suited, the language processing results determined by the device 510 may indicate a low confidence or other metric indicating that the processing by the device 510 may not be as accurate as the processing done by the system 500.

The hybrid selector 624, of the device 510, may include a hybrid proxy (HP) 626 configured to proxy traffic to/from the system 500. For example, the HP 626 may be configured to send messages to/from a hybrid execution controller (HEC) 627 of the hybrid selector 624. For example, command/directive data received from the system 500 can be sent to the HEC 627 using the HP 626. The HP 626 may also be configured to allow the audio data 511 to pass to the system 500 while also receiving (e.g., intercepting) this audio data 511 and sending the audio data 511 to the HEC 627.

In at least some embodiments, the hybrid selector 624 may further include a local request orchestrator (LRO) 628 configured to notify the ASR component 650 about the availability of new audio data 511 that represents user speech, and to otherwise initiate the operations of local language processing when new audio data 511 becomes available. In general, the hybrid selector 624 may control execution of local language processing, such as by sending “execute” and “terminate” events/instructions. An “execute” event may instruct a component to continue any suspended execution (e.g., by instructing the component to execute on a previously-determined intent in order to determine a directive). Meanwhile, a “terminate” event may instruct a component to terminate further execution, such as when the device 510 receives directive data from the system 500 and chooses to use that remotely-determined directive data.

Thus, when the audio data 511 is received, the HP 626 may allow the audio data 511 to pass through to the system 500 and the HP 626 may also input the audio data 511 to the on-device ASR component 650 by routing the audio data 511 through the HEC 627 of the hybrid selector 624, whereby the LRO 628 notifies the ASR component 650 of the audio data 511. At this point, the hybrid selector 624 may wait for response data from either or both of the system 500 or the local language processing components. However, the disclosure is not limited thereto, and in some examples the hybrid selector 624 may send the audio data 511 only to the local ASR component 650 without departing from the disclosure. For example, the device 510 may process the audio data 511 locally without sending the audio data 511 to the system 500.

The local ASR component 650 is configured to receive the audio data 511 from the hybrid selector 624, and to recognize speech in the audio data 511, and the local NLU component 660 is configured to determine a user intent from the recognized speech, and to determine how to act on the user intent by generating NLU output data which may include directive data (e.g., instructing a component to perform an action). Such NLU output data may take a form similar to that as determined by the NLU component 560 of the system 500. In some cases, a directive may include a description of the intent (e.g., an intent to turn off {device A}). In some cases, a directive may include (e.g., encode) an identifier of a second device(s), such as kitchen lights, and an operation to be performed at the second device(s). Directive data may be formatted using Java, such as JavaScript syntax, or JavaScript-based syntax. This may include formatting the directive using JSON. In at least some embodiments, a device-determined directive may be serialized, much like how remotely-determined directives may be serialized for transmission in data packets over the network(s) 199. In at least some embodiments, a device-determined directive may be formatted as a programmatic application programming interface (API) call with a same logical operation as a remotely-determined directive. In other words, a device-determined directive may mimic a remotely-determined directive by using a same, or a similar, format as the remotely-determined directive.

An NLU hypothesis (output by the NLU component 660) may be selected as usable to respond to a natural language user input, and local response data may be sent (e.g., local NLU output data, local knowledge base information, internet search results, and/or local directive data) to the hybrid selector 624, such as a “ReadyToExecute” response. The hybrid selector 624 may then determine whether to use directive data from the on-device components to respond to the natural language user input, to use directive data received from the system 500, assuming a remote response is even received (e.g., when the device 510 is able to access the system 500 over the network(s) 199), or to determine output audio requesting additional information from the user.

The device 510 and/or the system 500 may associate a unique identifier with each natural language user input. The device 510 may include the unique identifier when sending the audio data 511 to the system 500, and the response data from the system 500 may include the unique identifier to identify which natural language user input the response data corresponds.

In at least some embodiments, the device 510 may include, or be configured to use, one or more skill components 690 that may work similarly to the skill component(s) 590 implemented by the system 500. The skill component(s) 690 may correspond to one or more domains that are used in order to determine how to act on a spoken input in a particular way, such as by outputting a directive that corresponds to the determined intent, and which can be processed to implement the desired operation. The skill component(s) 690 installed on the device 510 may include, without limitation, a smart home skill component (or smart home domain) and/or a device control skill component (or device control domain) to execute in response to spoken inputs corresponding to an intent to control a second device(s) in an environment, a music skill component (or music domain) to execute in response to spoken inputs corresponding to a intent to play music, a navigation skill component (or a navigation domain) to execute in response to spoken input corresponding to an intent to get directions, a shopping skill component (or shopping domain) to execute in response to spoken inputs corresponding to an intent to buy an item from an electronic marketplace, and/or the like.

Additionally or alternatively, the device 510 may be in communication with one or more skill systems 525. For example, a skill system 525 may be located in a remote environment (e.g., separate location) such that the device 510 may only communicate with the skill system 525 via the network(s) 199. However, the disclosure is not limited thereto. For example, in at least some embodiments, a skill system 525 may be configured in a local environment (e.g., home server and/or the like) such that the device 510 may communicate with the skill system 525 via a private network, such as a local area network (LAN).

As used herein, a “skill” may refer to a skill component 690, a skill system 525, or a combination of a skill component 690 and a corresponding skill system 525.

Similar to the manner discussed with regard to FIG. 5, the local device 510 may be configured to recognize multiple different wakewords and/or perform different categories of tasks depending on the wakeword. Such different wakewords may invoke different processing components of local device 510 (not illustrated in FIG. 6). For example, detection of the wakeword “Alexa” by the wakeword detector 520 may result in sending audio data to certain language processing components 692/skills 690 for processing while detection of the wakeword “Computer” by the wakeword detector may result in sending audio data different language processing components 692/skills 690 for processing.

Various machine learning techniques may be used to train and operate models to perform various steps described herein, such as user recognition, sentiment detection, image processing, dialog management, etc. Models may be trained and operated according to various machine learning techniques. Such techniques may include, for example, neural networks (such as deep neural networks and/or recurrent neural networks), inference engines, trained classifiers, etc. Examples of trained classifiers include Support Vector Machines (SVMs), neural networks, decision trees, AdaBoost (short for “Adaptive Boosting”) combined with decision trees, and random forests. Focusing on SVM as an example, SVM is a supervised learning model with associated learning algorithms that analyze data and recognize patterns in the data, and which are commonly used for classification and regression analysis. Given a set of training examples, each marked as belonging to one of two categories, an SVM training algorithm builds a model that assigns new examples into one category or the other, making it a non-probabilistic binary linear classifier. More complex SVM models may be built with the training set identifying more than two categories, with the SVM determining which category is most similar to input data. An SVM model may be mapped so that the examples of the separate categories are divided by clear gaps. New examples are then mapped into that same space and predicted to belong to a category based on which side of the gaps they fall on. Classifiers may issue a “score” indicating which category the data most closely matches. The score may provide an indication of how closely the data matches the category.

In order to apply the machine learning techniques, the machine learning processes themselves need to be trained. Training a machine learning component such as, in this case, one of the first or second models, requires establishing a “ground truth” for the training examples. In machine learning, the term “ground truth” refers to the accuracy of a training set's classification for supervised learning techniques. Various techniques may be used to train the models including backpropagation, statistical learning, supervised learning, semi-supervised learning, stochastic learning, or other known techniques.

FIG. 7 is a block diagram conceptually illustrating a device 510 that may be used with the system. FIG. 8 is a block diagram conceptually illustrating example components of a remote device, such as the natural language command processing system 500, which may assist with ASR processing, NLU processing, etc., and a skill system 525. A system (500/525) may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The server(s) may be configured to operate using one or more of a client-server model, a computer bureau model, grid computing techniques, fog computing techniques, mainframe techniques, utility computing techniques, a peer-to-peer model, sandbox techniques, or other computing techniques.

While the device 510 may operate locally to a user (e.g., within a same environment so the device may receive inputs and playback outputs for the user) he server/system 500 may be located remotely from the device 510 as its operations may not require proximity to the user. The server/system 500 may be located in an entirely different location from the device 510 (for example, as part of a cloud computing system or the like) or may be located in a same environment as the device 510 but physically separated therefrom (for example a home server or similar device that resides in a user's home or business but perhaps in a closet, basement, attic, or the like). One benefit to the server/system 500 being in a user's home/business is that data used to process a command/return a response may be kept within the user's home, thus reducing potential privacy concerns.

Multiple systems (500/525) may be included in the overall system 200 of the present disclosure, such as one or more natural language processing systems 500 for performing ASR processing, one or more natural language processing systems 500 for performing NLU processing, one or more skill systems 525, etc. In operation, each of these systems may include computer-readable and computer-executable instructions that reside on the respective device (500/525), as will be discussed further below.

Each of these devices (510/500/525) may include one or more controllers/processors (704/804), which may each include a central processing unit (CPU) for processing data and computer-readable instructions, and a memory (706/806) for storing data and instructions of the respective device. The memories (706/806) may individually include volatile random access memory (RAM), non-volatile read only memory (ROM), non-volatile magnetoresistive memory (MRAM), and/or other types of memory. Each device (510/500/525) may also include a data storage component (708/808) for storing data and controller/processor-executable instructions. Each data storage component (708/808) may individually include one or more non-volatile storage types such as magnetic storage, optical storage, solid-state storage, etc. Each device (510/500/525) may also be connected to removable or external non-volatile memory and/or storage (such as a removable memory card, memory key drive, networked storage, etc.) through respective input/output device interfaces (702/802).

Computer instructions for operating each device (510/500/525) and its various components may be executed by the respective device's controller(s)/processor(s) (704/804), using the memory (706/806) as temporary “working” storage at runtime. A device's computer instructions may be stored in a non-transitory manner in non-volatile memory (706/806), storage (708/808), or an external device(s). Alternatively, some or all of the executable instructions may be embedded in hardware or firmware on the respective device in addition to or instead of software.

Each device (510/500/525) includes input/output device interfaces (702/802). A variety of components may be connected through the input/output device interfaces (702/802), as will be discussed further below. Additionally, each device (510/500/525) may include an address/data bus (724/824) for conveying data among components of the respective device. Each component within a device (510/500/525) may also be directly connected to other components in addition to (or instead of) being connected to other components across the bus (724/824).

Referring to FIG. 7, the device 510 may include input/output device interfaces 702 that connect to a variety of components such as an audio output component such as a speaker 712, a wired headset or a wireless headset (not illustrated), or other component capable of outputting audio. The device 510 may also include an audio capture component. The audio capture component may be, for example, a microphone 720 or array of microphones, a wired headset or a wireless headset (not illustrated), etc. If an array of microphones is included, approximate distance to a sound's point of origin may be determined by acoustic localization based on time and amplitude differences between sounds captured by different microphones of the array. The device 510 may additionally include a display 716 for displaying content. The device 510 may further include a camera 718.

Via antenna(s) 722, the input/output device interfaces 702 may connect to one or more networks 199 via a wireless local area network (WLAN) (such as Wi-Fi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. Through the network(s) 199, the system may be distributed across a networked environment. The I/O device interface (702/802) may also include communication components that allow data to be exchanged between devices such as different physical servers in a collection of servers or other components.

The components of the device(s) 510, the natural language command processing system 500, or a skill system 525 may include their own dedicated processors, memory, and/or storage. Alternatively, one or more of the components of the device(s) 510, the natural language command processing system 500, or a skill system 525 may utilize the I/O interfaces (702/802), processor(s) (704/804), memory (706/806), and/or storage (708/808) of the device(s) 510, natural language command processing system 500, or the skill system 525, respectively. Thus, the ASR component 550 may have its own I/O interface(s), processor(s), memory, and/or storage; the NLU component 560 may have its own I/O interface(s), processor(s), memory, and/or storage; and so forth for the various components discussed herein.

As noted above, multiple devices may be employed in a single system. In such a multi-device system, each of the devices may include different components for performing different aspects of the system's processing. The multiple devices may include overlapping components. The components of the device 510, the natural language command processing system 500, and a skill system 525, as described herein, are illustrative, and may be located as a stand-alone device or may be included, in whole or in part, as a component of a larger device or system. As can be appreciated, a number of components may exist either on a system 500 and/or on device 510. For example, language processing 592/692 (which may include ASR 550/650), language output 593/693 (which may include NLG 579/679 and TTS 580/680), etc., for example as illustrated in FIGS. 5 and 6. Unless expressly noted otherwise, the system version of such components may operate similarly to the device version of such components and thus the description of one version (e.g., the system version or the local version) applies to the description of the other version (e.g., the local version or system version) and vice-versa.

As illustrated in FIG. 9, multiple devices (510a-510j, 500, 525) may contain components of the system and the devices may be connected over a network(s) 199. The network(s) 199 may include a local or private network or may include a wide network such as the Internet. Devices may be connected to the network(s) 199 through either wired or wireless connections. For example, a speech controllable device 510a, a smart phone 510b, a smart watch 510c, a tablet computer 510d, a vehicle 510e, a speech-controlled device with display 510f, a display/smart television 510g, a washer/dryer 510h, a refrigerator 510i, and a microwave 510j, etc. may be connected to the network(s) 199 through a wireless service provider, over a Wi-Fi or cellular network connection, or the like. Other devices are included as network-connected support devices, such as the natural language command processing system 500, the skill system(s) 525, and/or others. The support devices may connect to the network(s) 199 through a wired connection or wireless connection. Networked devices may capture audio using one-or-more built-in or connected microphones or other audio capture devices, with processing performed by ASR components, NLU components, or other components of the same device or another device connected via the network(s) 199, such as the ASR component 550, the NLU component 560, etc. of the natural language command processing system 500.

The concepts disclosed herein may be applied within a number of different devices and computer systems, including, for example, general-purpose computing systems, speech processing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and speech processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein. Further, unless expressly stated to the contrary, features/operations/components, etc. from one embodiment discussed herein may be combined with features/operations/components, etc. from another embodiment discussed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system may be implemented as in firmware or hardware.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

What is claimed is:

1. A computer-implemented method comprising:
determining first prompt data representing a task to generate an image, the first prompt data including a first plurality of examples usable to cause generation of the image;
processing, using a large language model (LLM), the first prompt data to generate first machine-generated natural language data;
processing, using a first machine learning model configured to generate image data, the first machine-generated natural language data to determine first image data;
processing, using a second machine learning model, the first image data to determine that the first image data corresponds to a target image;
based on the first image data corresponding to the target image, determining a second plurality of examples including the first machine-generated natural language data and at least a portion of the first plurality of examples;
determining training data including at least the second plurality of examples; and
using the training data to configure a third machine learning model for image data generation.

2. The computer-implemented method of claim 1, wherein determining the second plurality of examples further comprises:
determining a first value representing a semantic difference between the first machine-generated natural language data and a first example natural language input of the first plurality of examples;
determining a second value representing a semantic difference between the first machine-generated natural language data and a second example natural language input of the first plurality of examples;
determining a first semantic diversity value for a first list, the first list including the first example natural language input, the second example natural language input, and the first machine-generated natural language data, wherein the first semantic diversity value is an average of the first value and the second value;
determining a third value representing a semantic difference between the first example natural language input and the second example natural language input;
determining a fourth value representing a semantic difference between the first example natural language input and a third example natural language input of the first plurality of examples;
determining a second semantic diversity value for a second list, the second list including the first example natural language input, the second example natural language input, and the third example natural language input, wherein the second semantic diversity value is an average of the third value and the fourth value; and
based at least in part on the first semantic diversity value being greater than the second semantic diversity value, determining the second plurality of examples to include the first machine-generated natural language data, the first example natural language input, and the second example natural language input, and to exclude the third example natural language input.

3. The computer-implemented method of claim 1, wherein determining the second plurality of examples further comprises:
processing, using the second machine learning model, the first image data to determine a first value representing a likelihood that the first image data corresponds to the target image;
determining a second value representing a likelihood of a first example natural language input of the first plurality of examples resulting in generation of second image data that corresponds to the target image;
determining that the first value is greater than the second value; and
based on determining that the first value is greater than the second value, determining the second plurality of examples to include the first machine-generated natural language data and to exclude the first example natural language input.

4. The computer-implemented method of claim 1, further comprising:
determining second prompt data representing the task to generate an image, the second prompt data including the second plurality of examples;
processing, using the LLM, the second prompt data to generate second machine-generated natural language data;
processing, using the first machine learning model, the second machine-generated natural language data to determine second image data;
processing, using the second machine learning model, the second image data to determine that the second image data corresponds to the target image; and
based on the second image data corresponding to the target image, determining a third plurality of examples including the first machine-generated natural language data, the second machine-generated natural language data, and at least a portion of the second plurality of examples.

5. A computer-implemented method comprising:
determining first prompt data including a first task and a first plurality of examples;
processing, using a large language model (LLM), the first prompt data to determine first machine-generated data;
processing, using a first machine learning model, the first machine-generated data to determine first model output;
determining, using a second machine learning model, that the first model output corresponds to a target output; and
based on the first model output corresponding to the target output, determining a second plurality of examples including the first machine-generated data and at least a portion of the first plurality of examples, the second plurality of examples to be used for model training for at least the first task.

6. The computer-implemented method of claim 5, further comprising:
processing, using the second machine learning model, the first model output to determine a value representing a likelihood of the first model output corresponding to the target output.

7. The computer-implemented method of claim 6, wherein a first example of the first plurality of examples is associated with a first score representing a likelihood of a second model output, generated using the first example, corresponding to the target output, and
the method further comprises:
determining, based on the value, a second score associated with the first machine-generated data; and
based at least in part on the first score and the second score, determining the second plurality of examples to include the first machine-generated data and to exclude the first example.

8. The computer-implemented method of claim 5, further comprising:
determining a first value representing a semantic difference between the first machine-generated data and a first example of the first plurality of examples;
determining a second value representing a semantic difference between the first machine-generated data and a second example of the first plurality of examples;
determining a third value representing a semantic difference between the first example and the second example; and
based at least in part on the first value, the second value and the third value, determining the second plurality of examples to include the first machine-generated data and the first example and to exclude the second example.

9. The computer-implemented method of claim 5, wherein the first plurality of examples is an ordered list of examples with a first example being last in the ordered list, and
the method further comprises:
determining the second plurality of examples by replacing the first example with the first machine-generated data in the ordered list.

10. The computer-implemented method of claim 5, further comprising:
determining second prompt data including the first task and the second plurality of examples;
processing, using the LLM, the second prompt data to determine a second machine-generated data;
processing, using the first machine learning model, the second machine-generated data to determine second model output;
determining that the second model output does not correspond to the target output; and
based on the second model output not corresponding to the target output, discarding the second machine-generated data.

11. The computer-implemented method of claim 5, wherein the first task is to generate a natural language response to a user input, and
wherein the first machine learning model is configured to generate the natural language response, and
wherein the first model output represents the natural language response.

12. The computer-implemented method of claim 5, wherein the first task is to generate an image in response to a user input, and
wherein the first machine learning model is configured to generate the image, and
wherein the first model output represents the image.

13. A system comprising:
at least one processor; and
at least one memory including instructions that, when executed by the at least one processor, cause the system to:
determine first prompt data including a first task and a first plurality of examples;
process, using a large language model (LLM), the first prompt data to determine first machine-generated data;
process, using a first machine learning model, the first machine-generated data to determine first model output;
determine, using a second machine learning model, that the first model output corresponds to a target output; and
based on the first model output corresponding to the target output, determine a second plurality of examples including the first machine-generated data and at least a portion of the first plurality of examples, the second plurality of examples to be used for model training for at least the first task.

14. The system of claim 13, wherein the at least one memory includes further instructions that, when executed by the at least one processor, further cause the system to:
process, using the second machine learning model, the first model output to determine a value representing a likelihood of the first model output corresponding to the target output.

15. The system of claim 14, wherein a first example of the first plurality of examples is associated with a first score representing a likelihood of a second model output, generated using the first example, corresponding to the target output, and
wherein the at least one memory includes further instructions that, when executed by the at least one processor, further cause the system to:
determining, based on the value, a second score associated with the first machine-generated data; and
based at least in part on the first score and the second score, determining the second plurality of examples to include the first machine-generated data and to exclude the first example.

16. The system of claim 13, wherein the at least one memory includes further instructions that, when executed by the at least one processor, further cause the system to:
determine a first value representing a semantic difference between the first machine-generated data and a first example of the first plurality of examples;
determine a second value representing a semantic difference between the first machine-generated data and a second example of the first plurality of examples;
determine a third value representing a semantic difference between the first example and the second example; and
based at least in part on the first value, the second value and the third value, determine the second plurality of examples to include the first machine-generated data and the first example and to exclude the second example.

17. The system of claim 13, wherein the first plurality of examples is an ordered list of examples with a first example being last in the ordered list, and
wherein the at least one memory includes further instructions that, when executed by the at least one processor, further cause the system to:
determine the second plurality of examples by replacing the first example with the first machine-generated data in the ordered list.

18. The system of claim 13, wherein the at least one memory includes further instructions that, when executed by the at least one processor, further cause the system to:
determine second prompt data including the first task and the second plurality of examples;
process, using the LLM, the second prompt data to determine second machine-generated data;
process, using the first machine learning model, the second machine-generated data to determine second model output;
determine that the second model output does not correspond to the target output; and
based on the second model output not corresponding to the target output, discard the second machine-generated data.

19. The system of claim 13, wherein the first task is to generate a natural language response to a user input,
wherein the first machine learning model is configured to generate the natural language response, and
wherein the first model output represents the natural language response.

20. The system of claim 13, wherein the first task is to generate an image in response to a user input, and
wherein the first machine learning model is configured to generate the image, and
wherein the first model output represents the image.
